(19) United States
(12) Patent Application Publication
(10) Pub. No.: US 2018/0097916 A1
(43) Pub. Date: Apr. 5, 2018

(54) COMMUNICATION APPARATUS AND COMMUNICATION METHOD

(71) Applicant: FUJITSU LIMITED, Kawasaki-shi (JP)

(72) Inventors: Isamu Fukuda, Yokohama (JP); Katsuhiko Negoto, Yokohama (JP); Kazuhiro Yasuno, Yokohama (JP); Akihiro KAMEDA, Kawasaki (JP); MASUMI KOBAYASHI, Kawasaki (JP); KIYOHISA HOSHINO, Yokohama (JP)

(73) Assignee: FUJITSU LIMITED, Kawasaki-shi (JP)

(21) Appl. No.: 15/704,821

(22) Filed: Sep. 14, 2017

(30) Foreign Application Priority Data
Sep. 30, 2016 (JP) 2016-194753

(51) Int. Cl. H04L 29/06; H04W 40/04; H04W 40/24; H04L 12/26

(52) U.S. Cl. CPC H04L 69/22; H04W 40/04; H04W 88/08; H04W 40/248; H04L 43/0847; H04L 69/18

(57) ABSTRACT

A communication apparatus includes a decipher deciphering received ciphered data, a first processor configured to generate, when receiving deciphered data for which the ciphered data is deciphered, a header of a first protocol including the deciphered data in a payload and an addition value for which the deciphered data is added in a predetermined size unit, a packet including the deciphered data, the header of the first protocol, and a header of a second protocol and a header of a third protocol, a second processor configured to calculate a checksum value set to the header of the second protocol using the addition value and a transmitter configured to transmit the packet to which the checksum value is set.

### CROSS-REFERENCE TO RELATED APPLICATION

This application is based upon and claims the benefit of priority of the prior Japanese Application No. 2016-194753 filed on Sep. 30, 2016, the entire contents of which are incorporated herein by reference.

### FIELD

The present invention relates to an apparatus and a communication apparatus and a communication method.

BACKGROUND

Some base stations (referred to as eNBs (evolved Node Bs)) in Long Term Evolution (LTE) and LTE Advanced which are wireless communication standards have a configuration as below. The base station receives a Packet Data Convergence Protocol (PDCP) packet including user data by wireless communication with a wireless terminal (referred to as UE (User Equipment)). The base station deciphers the user data in the PDCP packet, and imparts GPRS Tunneling Protocol User Plane (GTP-U, simply described also as GTP), User Datagram Protocol (UDP) and Internet Protocol (IP) headers (generates a packet). The base station generates a checksum value of UDP using a part of the user data, the GTP header, the UDP header and the IP header, and sets it to the UDP header. An IP packet is transferred to a transmission path interface through an internal bus inside the base station. In the transmission path interface, a UDP checksum is calculated. In the case that the UDP checksum is correct, the IP packet is sent out to a transmission path (a cable LAN (Local Area Network) for example) connected to a core network. For further information, see Japanese Laid-Open Patent Publication No. 2007-189296.

### SUMMARY

However, the base station including the above-described configuration has a following problem. That is, since a UDP checksum value is calculated before transfer by the internal bus, access to the user data that is deciphered and stored in a memory and addition in units of 2 bytes (16 bits) of the user data are performed. There is a risk that such access to the user data and processing time invite increase in transmission delay.

An aspects of embodiments is a communication apparatus 1. The communication apparatus includes:

a decipher configured to deciphers received ciphered data;

a first memory;

a first processor coupled to the first memory and configured to:

generate, when receiving deciphered data for which the ciphered data is deciphered, a header of a first protocol including the deciphered data in a payload and an addition value for which the deciphered data is added in a predetermined size unit, a packet including the deciphered data, the header of the first protocol, and a header of a second protocol and a header of a third protocol, a layer of the second protocol and the third protocol being lower than a layer of the first protocol;

a second memory;

a second processor coupled to the second memory and configured to calculate a checksum value set to the header of the second protocol using the addition value; and

a transmitter configured to transmit the packet to which the checksum value is set.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 illustrates an example of a wireless communication system;

FIG. 2 illustrates a base station relating to a reference example;

FIG. 3 illustrates a configuration example of the base station relating to an embodiment;

FIG. 4 illustrates a configuration example of a control circuit illustrated in FIG. 3;

FIG. 5 is an explanatory drawing of processing performed in the base station relating to an embodiment 1;

FIG. 6 illustrates a format example of an IP packet in an IP terminating unit;

FIG. 7 is a flowchart illustrating a processing example of a GTP terminating unit;

FIG. 8 is a flowchart illustrating a processing example of the IP terminating unit;

FIG. 9 illustrates a configuration example of the control circuit of the base station in an embodiment 2;

FIG. 10 is an action explanatory drawing of the embodiment 2;

FIG. 11 is an explanatory drawing of a processing procedure of the GTP terminating unit, a signal relay unit, and the IP terminating unit in the base station relating to the embodiment 2;

FIG. 12 is a flowchart illustrating a processing example of the signal relay unit in the embodiment 2;

FIG. 13 illustrates a configuration example of the control circuit of the base station relating to an embodiment 3;

FIG. 14 is a diagram describing a processing procedure of the base station relating to the embodiment 3;

FIG. 15 is a flowchart illustrating a processing example of the GTP terminating unit in the embodiment 3;

FIG. 16 is a flowchart illustrating a processing example of the IP terminating unit in the embodiment 3; and

FIG. 17 is a diagram illustrating a comparison between the embodiments 1-3 and the reference example.

### DESCRIPTION OF EMBODIMENTS

Hereinafter, embodiments of a communication apparatus and a communication method will be described with reference to the drawings. A configuration of the embodiments is an example and the present invention is not limited to the configuration of the embodiments.

In the embodiments, a mobile communication system (wireless communication system) including a base station will be described. However, the wireless communication system is, for example, LTE or LTE Advanced. However, a standard other than the wireless communication standards may be applied. In addition, in the embodiments, the case that the base station is an example of the communication apparatus will be described. However, the communication apparatus may be a communication apparatus (such as a relay apparatus) other than the base station.

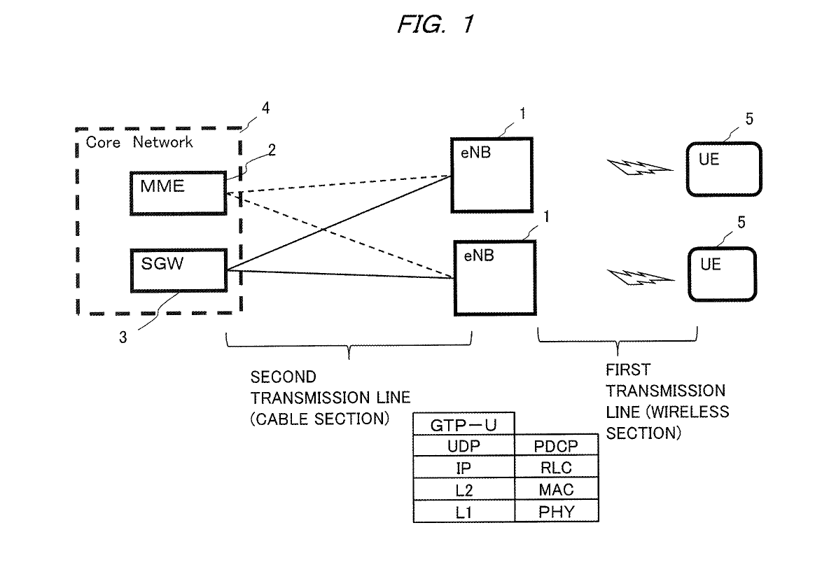

FIG. 1 is a diagram illustrating an LIE network system that is an example of the wireless communication system. Abase station (eNB) 1 forming a wireless network is connected with a MobilityManagement Entity (MME) 2 in a control plane (C plane) (see a broken line connecting the eNB and the MME). In addition, the base station 1 is connected with a serving gateway (SGW) 3 in a user plane (U plane) (see a solid line connecting the eNB and the MME).

The MME 2 and the SGW 3 are nodes forming a core network 4, and the MME 2 performs call control of a wireless terminal (UE) 5, position registration of the wireless terminal 5, and establishment control of a packet transmission path (referred to as a bearer) between the SGW 3 and the base station 1, or the like. The SGW 3 relays a packet from the wireless terminal 5 arriving through the bearer. Note that the packet relayed by the SGW 3 is transferred to an external network such as the Internet through a PGW (Packet data Network Gateway) not illustrated in the figure, and is delivered to a destination connected to the external network.

Regarding user data transmitted from the wireless terminal 5 (described as the terminal 5, hereinafter), a first transmission path which is a wireless section is formed between the terminal 5 and the base station 1, and a second transmission path is formed between the base station 1 and the SGW 3. As the second transmission path, a cable LAN (Local Area Network) is applied for example.

Since the terminal 5 transmits the user data to the base station 1 using the first transmission path, the terminal 5 transmits a radio signal based on a protocol stack of PHY, Media Access Control (MAC), Radio Link Control (RLC) and PDCP.

The base station 1 which receives the radio signal from the terminal 5 performs protocol conversion processing of converting the radio signal to a GTP packet. That is, the base station 1 converts the radio signal to a packet based on the protocol of L1 (layer 1), L2 (layer 2), IP, UDP and GTP-U. The base station 1 transmits the packet to the SGW 3 using the bearer (GTP tunnel) established beforehand on the second transmission path (physical link) connecting the base station 1 and the SGW 3.

### REFERENCE EXAMPLE

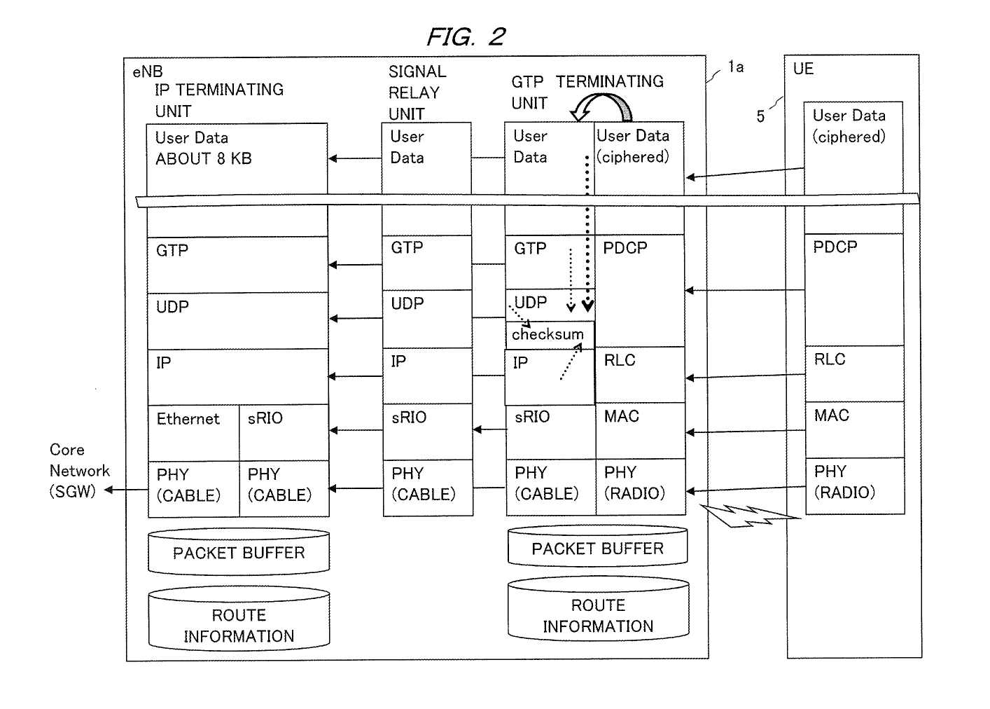

FIG. 2 is a diagram illustrating a base station 1a relating to the reference example. In FIG. 2, the base station 1a includes a GTP terminating unit, a signal relay unit, and an IP terminating unit. The GTP terminating unit performs terminating processing of GTP and UDP, adds the entire user data and a part of a GTP header, a UDP header and an IP header in units of 2 bytes (16 bits), and calculates a UDP checksum. The signal relay unit relays a signal transmitted through an internal bus of the base station 1a. For the internal bus, serial rapid IO (sRIO), an ATM (asynchronous transfer mode), a PCI (Peripheral Component Interconnect) bus or a LAN or the like is applied for example. As an example, use of the sRIO is illustrated. The IP terminating unit transmits an IP packet.

Specific processing is as follows. The terminal 5 (UE) transmits a PDCP packet including ciphered user data to the base station 1a (eNB). The GTP terminating unit of the base station 1a deciphers the ciphered user data. The deciphered user data is stored in a memory not illustrated in the figure.

The GTP terminating unit generates the GTP header, the UDP header and the IP header based on information included in a PDCP header and route (path) information (information on the bearer), and stores them in the memory. The GTP terminating unit generates a UDP checksum value according to RFC768. Therefore, the GTP terminating unit reads the entire user data and a part of the GTP header, the UDP header and the IP header from the memory, and adds them in units of 2 bytes (16 bits) (obtains a total sum). In the case that a carry-over is generated, 1 is added further. Apart of the UDP header includes a UDP data length, a destination port number and a transmission source port number, and a part of the IP header includes a protocol number, an IP destination address and an IP transmission source address.

The GTP terminating unit sets a value for which an addition result is inverted (taking a complement of 1 of the total sum) to a value of a checksum field of the UDP header. The GTP terminating unit loads the data (the user data, the GTP header, the UDP header, and the IP header) of the GTP packet obtained by the processing so far onto a sRIO frame, and transmits it to the IP terminating unit through the signal relay unit. The data of the GTP packet is divided in accordance with a size of the sRIO frame of a fixed length, and each divided data is transferred inside the base station 1a by the sRIO frame. The signal relay unit relays the sRIO frame.

The IP terminating unit transmits the GTP packet that is transferred by the sRIO frame and assembled to the core network through the second transmission path (bearer: GTP-U tunnel). In the core network (SGW 3), the UDP checksum of the GTP packet is calculated, and the processing (relay or the like) is performed in the case that the checksum is correct.

However, the base station 1a relating to the reference example described above has following problems. In the base station la, a communication system in which internal data transmission from the GTP terminating unit to the IP terminating unit is accompanied by division/assembly of the data of the sRIO or the like is used. By CRC (Cycle Redundancy Check) check, an error generated during the division/assembly is not detected. Therefore, an error generated during the division/assembly may be detected by imparting the UDP and IP headers and calculating the UDP checksum before the transmission in the GTP terminating unit and checking the UDP checksum on a reception side. Therefore, the following two problems arise.

First, the UDP checksum is calculated in the GTP terminating unit. At the time, addition in units of 2 bytes is performed for the user data of about 8000 bytes (8 KB) for example stored in the memory (packet buffer).

For the addition processing, memory access of a processor (Central Processing Unit (CPU)) is performed for each GTP packet so that waiting time of the processing is generated depending on a number of the GTP packets. In this way, there is a risk that the memory access for UDP checksum calculation invites increase in transmission delay inside the base station 1a of the user data. Secondly, a data amount of a transmission object is increased by generation of the UDP header and the IP header. As a result, there is a risk that relay processing of the UDP header and the IP header transmitted to the IP terminating unit becomes a factor of increasing the transmission delay.

In the embodiments described below, the base station 1 and a checksum generation method of the base station 1 capable of solving the above-described problems and suppressing the increase in the transmission delay will be described.

### Embodiment 1

Hereinafter, the base station 1 (base station 1A) relating to the embodiment 1 will be described. The base station 1A receives a PDCP packet (an example of ciphered data) including ciphered user data. The base station 1A is an example of “communication apparatus”. In the case of executing cipher cancelation (deciphering) of the user data in the PDCP packet, the base station 1A stores the addition result in units of 2 bytes of the user data (the total sum in units of 2 bytes) in a register (referred to as a SUM register). The addition result (referred to as a SUM value) is used in checksum calculation of the UDP header. The SUM value is an example of “addition value”.

Thus, a situation that the deciphered user data is stored in the memory and is then read (accessed) from the memory for the checksum calculation as in the reference example may be avoided. Thus, time needed for the checksum calculation may be shortened, and the increase in the transmission delay may be suppressed.

### <Configuration of Base Station>

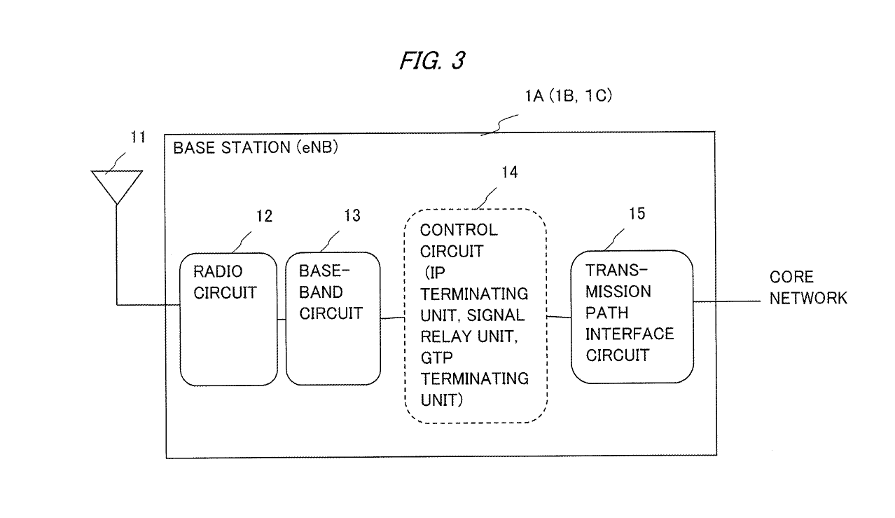

FIG. 3 illustrates a configuration example of the base station 1 (described as the base station 1A) relating to the embodiment. The base station 1A includes an antenna 11, a radio circuit 12, a baseband circuit 13, a control circuit 14, and a transmission path interface circuit 15.

The antenna 11 is used for transmission and reception of the radio signal to/from the terminal 5 through the first transmission path (wireless section). The radio circuit 12 performs conversion processing of the radio signal and a baseband signal. The baseband circuit 13 performs conversion processing of the baseband signal and the data (packet). That is, the baseband circuit 13 obtains the PDCP packet by demodulating and deciphering processing to the baseband signal from the radio circuit 12. On the other hand, the baseband circuit 13 encodes and modulates the PDCP packet and generates the baseband signal.

The control circuit 14 is an assembly of circuits operated as the GTP terminating unit, the signal relay unit and the IP terminating unit. The transmission path interface circuit 15 sends out the packet outputted from the control circuit 14 to the second transmission path (cable LAN) connected to the core network 4. In addition, the transmission path interface circuit receives the packet from the second transmission path.

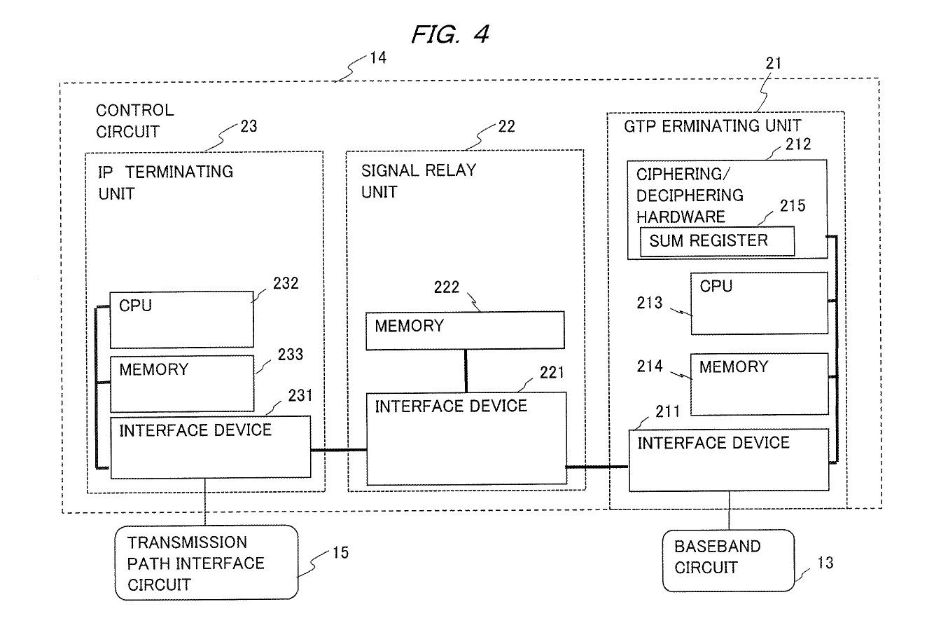

FIG. 4 illustrates a configuration example of the control circuit 14. The control circuit 14 includes a GTP terminating unit 21, a signal relay unit 22, and an IP terminating unit 23. The GTP terminating unit 21 includes an interface device 211, and the signal relay unit 22 includes an interface device 221. The IP terminating unit 23 includes an interface device 231.

The interface device 211 and the interface device 221 are connected by an internal bus line, the interface device 221 and the interface device 231 are connected by an internal bus line, and an internal transmission path is formed. The interface device 211, the interface device 221, and the interface device 231 are circuits for communication that transmit, relay and receive the data, and are formed using a Field Programmable Gate Array (FPGA) for example. However, it is not compulsory to use the FPGA.

The interface device 211 divides a data block of the transmission object into blocks (divided blocks) of a predetermined size (256 bytes for example in the case of the sRIO), based on a specification of the sRIO which is an example of the communication system. Each of the divided blocks is loaded onto the sRIO frame and transmitted.

The interface device 221 receives each sRIO frame. The interface device 221 assembles the divided data taken out from each received sRIO frame, and generates the original data block. The interface device 231 receives the data block transmitted from the interface device 221. Note that the interface device 221 may relay each sRIO frame to the interface device 231 and the original data block may be assembled in the interface device 231.

The GTP terminating unit 21 includes ciphering/deciphering hardware 212, a Central Processing Unit (CPU) 213, and a memory 214, in addition to the interface device 211 described above. The ciphering/deciphering hardware 212, the CPU 213, the memory 214, and the interface device 211 are coupled to each other.

The ciphering/deciphering hardware 212 is a circuit that performs ciphering processing and deciphering processing (cipher cancellation) of the user data based on the PDCP. The ciphering/deciphering hardware 212 generates the user data for which the ciphered user data (an example of ciphered data) is deciphered. The deciphered user data (an example of deciphered data) is stored in the memory 214. The ciphering/deciphering hardware 212 includes a SUM register 215. The SUM register 215 is an example of “storage unit (storage)”.

Upon the deciphering processing of the ciphered user data received from the terminal 5, the ciphering/deciphering hardware 212 performs the addition (calculation of the total sum) in units of 2 bytes of the deciphered user data, and stores the addition result (SUM value) in the SUM register 215. The unit of 2 bytes is an example of a predetermined byte unit, and the predetermined byte unit is not limited to 2 bytes. The SUM value is transmitted from the interface device 211 to the IP terminating unit 23. The SUM value is loaded onto a free area of the header or a payload of the sRIO frame. The SUM value may be transferred by the sRIO frame together with the corresponding user data or the GTP header, and may be transmitted by the sRIO frame separately from the user data and the GTP header.

Note that the ciphering/deciphering hardware 212 is provided in the embodiment 1. However, there may be a case that the processing performed in the ciphering/deciphering hardware 212 is performed in the CPU 213 or the like and the ciphering/deciphering hardware 212 is omitted. In this case, a register provided in the CPU 213 for example may be used as the SUM register 215.

The memory 214 includes a main storage device and an auxiliary storage device. The main storage device is used as a development area of a program, a work area of the CPU 213, and a storage area or a buffer area of the data and the program. The main storage device is formed by a Random Access Memory (RAM) or a combination of the RAM and a Read Only Memory (ROM) for example.

The auxiliary storage device is used as the storage area of the data and the program. The auxiliary storage device is formed by a nonvolatile storage medium such as a hard disk drive (HDD), a Solid State Drive (SSD), a flash memory, or an Electrically Erasable Programmable Read-Only Memory (EEPROM), for example. The memory 214 (each of the main storage device and the auxiliary storage device) is an example of “storage device”, “storage medium”, “memory” and “storage unit”.

The CPU 213 performs an operation and the processing as the GTP terminating unit 21 by executing the program stored in the memory 214. For example, the CPU 213 controls the ciphering/deciphering hardware 212 and the interface device 211. In addition, the CPU 213 performs generation of the GTP header or the like using the information of the PDCP header and the information of the route information (bearer (GTP tunnel)) stored in the memory 214 or the like. The CPU 213 is an example of “control device”, “control unit”, “controller” and “processor”.

The signal relay unit 22 includes a memory 222 other than the interface device. For the memory 222, the configuration and the storage medium described for the memory 214 may be applied. The memory 222 is used as a buffer that tentatively stores the sRIO frame for example.

The IP terminating unit 23 includes a CPU 232 and a memory 233 other than the interface device. For the memory 233, the configuration and the storage medium described for the memory 214 maybe applied. The CPU 232 performs the processing as the IP terminating unit 23 by executing the program stored in the memory 233. For example, the CPU 232 performs the generation of the UDP header and the IP header and the calculation of the UDP checksum. At the time, in the CPU 232, the addition result (the total sum in units of 2 bytes of the user data) received from the GTP terminating unit 21 is used in the calculation of the UDP checksum. The CPU 232 is an example of “control device”, “control unit”, “controller” and “processor”.

The CPU used as the CPU 213 and the CPU 232 is also referred to as an MPU (Microprocessor) or a processor. The CPU is not limited to a single processor and may have a multiprocessor configuration. In addition, the single CPU connected by a single socket may have a multicore configuration. At least a part of the processing performed in the CPU may be performed in a multicore CPU or a plurality of CPUs. At least a part of the processing performed in the CPU may be performed in the processor other than the CPU, for example, an exclusive processor such as a Digital Signal Processor (DSP), a Graphics Processing Unit (GPU), an arithmetic operation processor, a vector processor or an image processor.

In addition, at least a part of the processing performed in the CPU may be performed in an integrated circuit (IC) or other digital circuits. Furthermore, the integrated circuit and the digital circuit may include an analog circuit. The integrated circuit includes an LSI, an Application Specific Integrated Circuit (ASIC), and a programmable logic device (PLD). The PLD includes a Field-Programmable Gate Array (FPGA), for example. At least a part of the processing performed in the CPU may be executed by the combination of the processor and the integrated circuit. The combination is referred to as a microcontroller (MCU), a SoC (System-on-a-chip), a system LSI or a chip set or the like, for example.

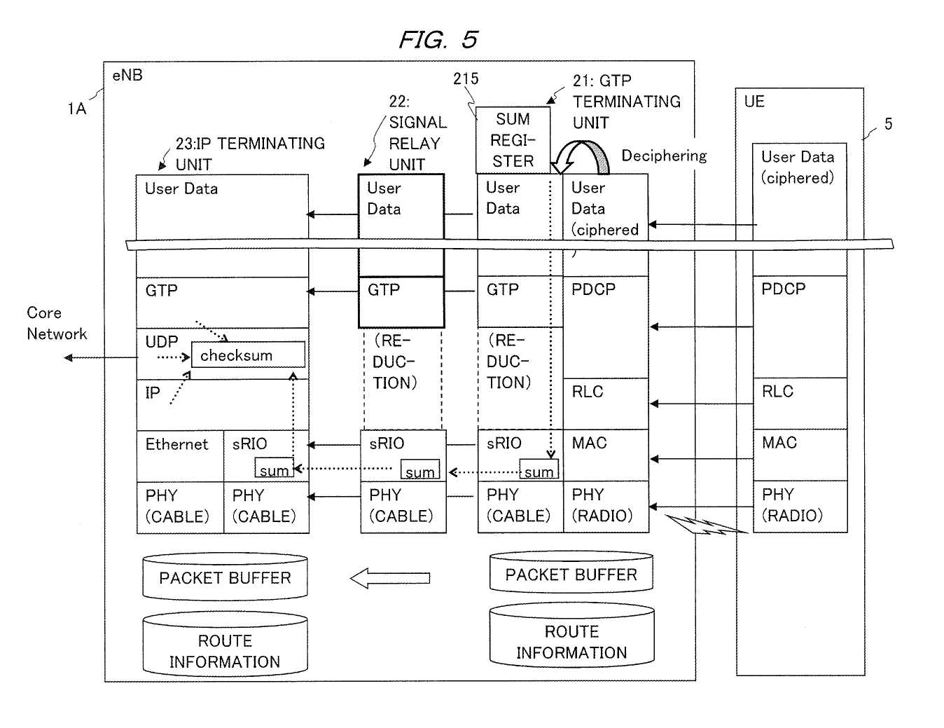

FIG. 5 is an explanatory drawing of the processing performed in the base station 1A relating to the embodiment 1. In the base station 1A relating to the embodiment 1 illustrated in FIG. 5, differently from the reference example (FIG. 2), the GTP terminating unit 21 does not generate the UDP and IP headers. The UDP and IP headers are generated in the IP terminating unit 23. Thus, a data amount transmitted from the GTP terminating unit 21 to the IP terminating unit 23 may be reduced, and the transmission delay may be suppressed.

In addition, in the base station 1A, upon deciphering by the ciphering/deciphering hardware 212, the addition value in units of 2 bytes for the entire user data is stored in the SUM register 215. Thus, the access to the deciphered user data stored in the memory 214 for the calculation of the UDP checksum may be avoided. By avoiding the access, access standby and processing standby may be avoided. That is, the increase in the transmission delay may be suppressed.

Furthermore, in the base station 1A, the SUM value stored in the SUM register 215 is transmitted to the IP terminating unit 23 by a communication packet (sRIO frame) inside the base station 1A, and is used in the UDP checksum calculation. Thus, need of the checksum calculation of the entire user data executed using the CPU and the memory in the GTP terminating unit 21 in the reference example is eliminated.

In addition, since the UDP header generation is executed in the IP terminating unit 23, bit transformation in a relay path between the GTP terminating unit 21 and the IP terminating unit 23 may be verified by the checksum calculation in an opposite apparatus (SGW 3 for example) of the base station 1A. Note that, when a security gateway and other relay apparatuses are interposed between the base station 1A and the SGW 3, the checksum calculation may be executed in the security gateway and/or other relay apparatuses.

In the sRIO of a layer lower than the GTP, the data block of the transmission object is divided in units of 256 bytes, and each divided block is transmitted by the sRIO frame. For the bit transformation in the single sRIO frame, abnormality may be detected inside the base station 1A by the CRC check for example, and the data may be discarded. However, the bit transformation during the division and the assembly is not detected by the CRC check.

In the base station 1A, the value stored in the SUM register 215 is used in the calculation of the UDP checksum and is reflected on the UDP checksum value. In the case that the bit transformation occurs during the division and the assembly, inconsistency of a calculation result of the UDP checksum and the checksum value of the UDP header in the opposite apparatus of a transmission destination of the packet is detected in the opposite apparatus. Thus, the abnormality (error) due to the division and the assembly may be detected.

Hereinafter, using FIG. 5, a specific processing procedure of the GTP terminating unit 21, the signal relay unit 22 and the IP terminating unit 23 in the base station 1A will be described. The operation and the processing of the GTP terminating unit 21 other than the processing performed by the ciphering/deciphering hardware 212 and the interface device 211 are performed by the CPU 213.

The terminal 5 transmits the PDCP packet including the ciphered user data to the base station 1A by radio. The PDCP packet is stored in the memory 214 (the packet buffer formed in the memory 214).

The GTP terminating unit 21 (ciphering/deciphering hardware 212) of the base station 1 deciphers the ciphered user data, and stores it in the memory 214. At the time, the ciphering/deciphering hardware 212 stores the addition result for every 2 bytes of the deciphered user data in the SUM register 215. Finally, the total sum of the deciphered user data is stored in the SUM register 215. Note that 1 is added further in the case of the carry-over by the addition.

The GTP terminating unit 21 (CPU 213) stores the value of the SUM register 215 in the free area of the header or the payload of the sRIO frame generated in the interface device 211. The SUM value is relayed in the signal relay unit 22 (interface device 221) by transfer of the sRIO frame and is received in the IP terminating unit 23 (interface device 231). The SUM value is stored in a predetermined area of the memory 233.

The GTP terminating unit 21 (CPU 213) generates the GTP header from the PDCP header and the route information present in the memory 214. The GTP terminating unit 21 (CPU 213) sends GTP data (the user data and the GTP header) to the interface device 211. The interface device 211 divides the GTP data (data block) into the plurality of divided blocks, loads them onto the sRIO frame and transmits them. The corresponding SUM value maybe transmitted when the data block is transmitted. For example, the SUM value may be provided on an end of the data block and may be transmitted in a state of being handled as a part of the data block.

The sRIO frame is received in the signal relay unit 22 (interface device 221), and the signal relay unit 22 restores the original data block and the SUM value from the plurality of sRIO frames. The data block and the SUM value are transmitted from the interface device 221 to the interface device 231 (IP terminating unit 23). However, the sRIO frame may be relayed to the IP terminating unit 23 in the signal relay unit 22, and the data block and the SUM value may be restored in the IP terminating unit.

The IP terminating unit 23 generates the IP header, the UDP header and the GTP header from the GTP header and the route information. In other words, the IP terminating unit 23 generates the IP packet including the user data, the GTP header including the user data in the payload, the UDP header, and the IP header. The user data is an example of the deciphered data, the GTP is an example of a first protocol, the UDP is an example of a second protocol, the IP is an example of a third protocol, and the IP packet is an example of the packet.

The IP terminating unit 23 adds a part of the GTP header, the UDP header and the IP header in units of 2 bytes (calculates the total sum). The IP terminating unit 23 reflects the SUM value calculated in the GTP terminating unit 21 on the addition result of the headers.

The IP terminating unit 23 inverts the addition value (total sum) of the headers on which the SUM value is already reflected, and sets it to the checksum value of the UDP header. The IP terminating unit 23 transmits the IP packet to the core network 4.

However, the GTP terminating unit 21 and the IP terminating unit 23 of the base station 1A may perform the operation described in the reference example in the case that the size of the user data is smaller than a predetermined size (about 100 bytes for example). In other words, the operation illustrated in FIG. 5 may be performed in the case that the size of the user data is larger than the predetermined size.

In the core network 4, the opposite apparatus, the SGW 3 for example, calculates the UDP checksum of the IP packet, and performs the processing (decapsulation of the GTP packet or the like) when it is correct.

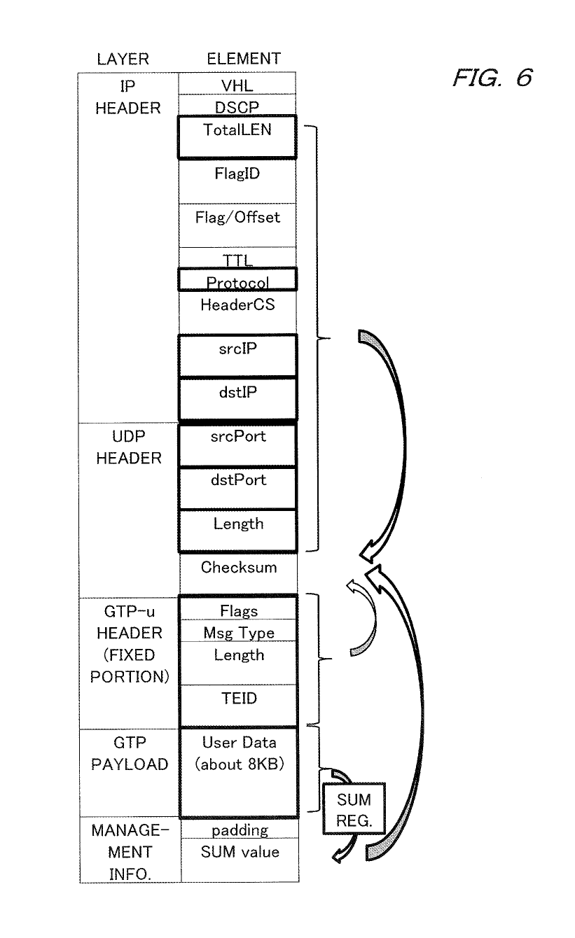

FIG. 6 illustrates a format example of the IP packet in the IP terminating unit. The IP packet includes a GTP payload, the GTP header, the UDP header, and the IP header in an order from a high-order layer. A field part surrounded by thick lines in FIG. 6 is used in the calculation of the UDP checksum. Specifically, a total length (Total LEN) field, a protocol (Protocol) field, a transmission source IP address (srcIP) field and a destination IP address (dstIP) field of the IP header become objects. Further, the respective fields of a transmission source port number (srcPort), a destination port number (dstPort), and a UDP data length (Length) of the UDP header become calculation objects.

Further, the GTP header (GTP-u header) and the GTP payload become the calculation objects. Management information is sometimes provided with padding as needed. In the embodiment 1, in the calculation of the UDP checksum in the IP terminating unit 23, the GTP payload is not used, and the SUM value obtained in the GTP terminating unit 21 is used.

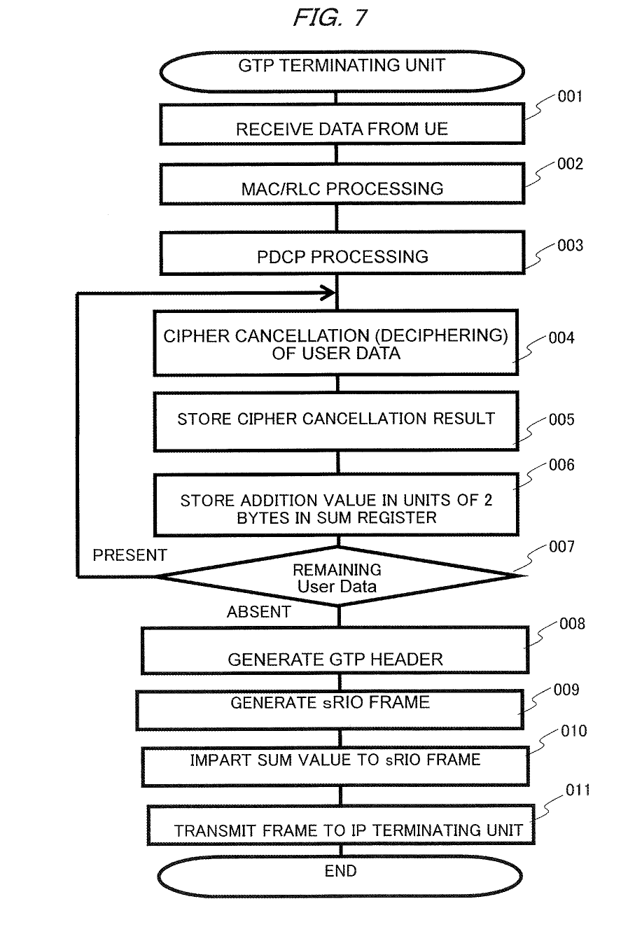

FIG. 7 is a flowchart illustrating a processing example of the GTP terminating unit. In the processing of 001, the GTP terminating unit 21 receives the data (PDCP packet) from the terminal 5 (UE). In the processing of 002, the GTP terminating unit 21 performs the processing of a MAC layer and an RLC layer. In the processing of 003, the GTP terminating unit 21 performs the processing of a PDCP layer.

In the processing of 004, the GTP terminating unit 21 performs cipher cancellation (deciphering) of the user data. In the processing of 005, the GTP terminating unit 21 stores a cipher cancellation result in a predetermined area of the memory 214. In the processing of 006, the user data deciphered by the ciphering/deciphering hardware 212 is added in units of 2 bytes, and the obtained addition value is stored in the SUM register 215. The processing of 004-006 is executed for the entire user data (all of the user data) (007). Thus, the SUM value for the user data is stored in the SUM register 215.

When the deciphering of the user data and the storage of the SUM value are ended, the GTP terminating unit 21 generates the GTP header in the processing of 008. In the processing of 009, the GTP terminating unit 21 generates a single or a plurality of sRIO frames for transmitting the user data and the GTP header (data block). In the processing of 010, the SUM value is added (stored) in the free area of the sRIO frame. Note that the data block (the GTP header and the user data) is divided in units of 256 bytes, and each divided block is transmitted to the IP terminating unit 23 by the sRIO frame. At the time, when the SUM value is over the sRIO frames, the padding of a predetermined size (1 byte) is inserted.

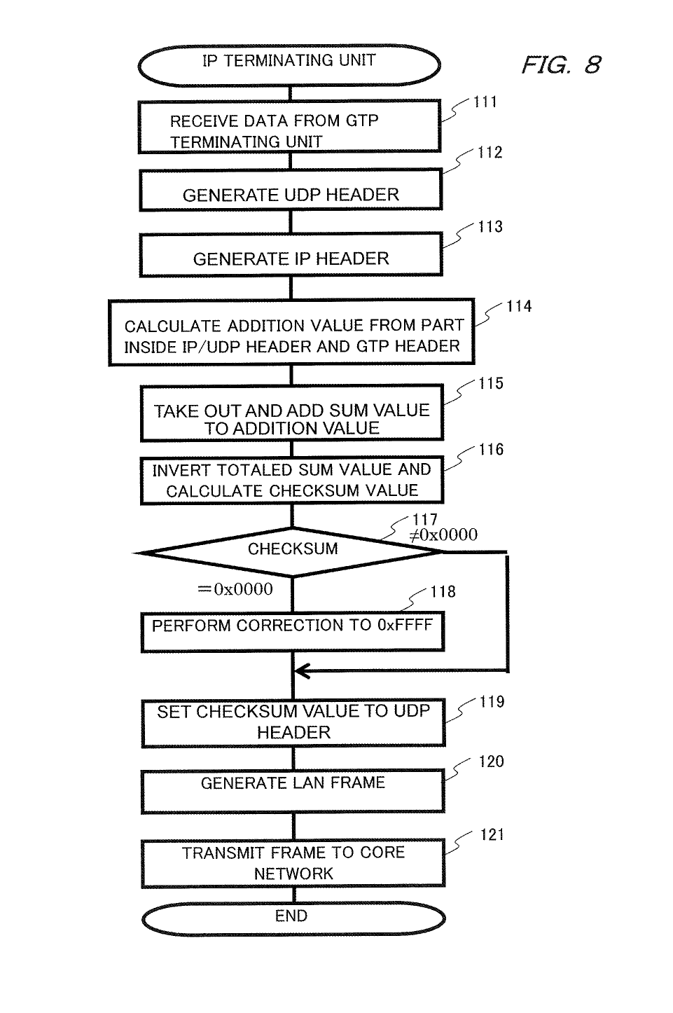

FIG. 8 is a flowchart illustrating a processing example of the IP terminating unit. In the processing of 111, the IP terminating unit 23 receives the data from the GTP terminating unit 21 through the signal relay unit 22. In the processing of 112, the IP terminating unit 23 generates the UDP header. In the processing of 113, the IP terminating unit 23 generates the IP header.

In the processing of 114, the IP terminating unit 23 calculates the addition value for which a part of the UDP and the IP headers (see FIG. 6) and the GTP header added in units of 2 bytes. In the processing of 115, the SUM value transferred from the GTP terminating unit 21 is added to the addition value (the total sum of the calculation objects of the UDP checksum is obtained). In the processing of 116, the IP terminating unit 23 calculates the value for which the value of the totaled SUM value (the addition result of the processing of 115) is inverted as the checksum value.

In the processing of 117, the IP terminating unit 23 determines whether the checksum value is 0x0000 (indicating invalidation of the checksum) or other than 0x0000. In the case that the checksum value is other than 0x0000, the processing advances to the processing of 119. In the case that the checksum value is 0x0000, the IP terminating unit 23 corrects the checksum value to 0xFFFF (the checksum value is 0 and valid) (118).

In the processing of 119, the checksum value obtained in the processing of 116 or 118 is set to the checksum field of the UDP header. In the processing of 120, the IP terminating unit 23 generates a LAN frame including the IP packet (120), and transmits it to the core network (121).

### Effects of Embodiment 1

In the embodiment 1, the base station 1A as the communication apparatus that receives the ciphered data (user data) includes the ciphering/deciphering hardware 212 (an example of a deciphering unit or a decipher) that deciphers the ciphered user data. The base station 1A includes the IP terminating unit 23 (CPU 232) that is an example of a generation unit or a generator. The IP terminating unit 23 generates a packet including the deciphered user data, the GTP header, the UDP header and the IP header in the case that the deciphered user data, the GTP header, and the SUM value for which at least the deciphered user data is added in units of 2 bytes are received. In addition, the IP terminating unit 23 calculates the UDP checksum value using the SUM value as an example of a calculation unit or a calculator. Furthermore, the IP terminating unit 23 (interface device 231) is operated as an example of “transmission unit (transmitter) ” that transmits the packet to which the UDP checksum value is set to the core network 4. In the embodiment 1, the CPU 213 is an example of “a first processor”, the memory 214 is an example of “a first memory”, the CPU 232 is an example of “a second processor coupled to a second memory”, and the memory 233 is an example of “a second memory”.

According to the base station 1A relating to the embodiment 1, since the memory access for the deciphered user data is not performed for the calculation of the UDP checksum, the increase in the transmission delay may be avoided. In addition, the abnormality during the division/assembly of the data block using the sRIO may be detected by the checksum calculation in the opposite apparatus.

### Embodiment 2

Next, abase station and a checksum generation method relating to the embodiment 2 will be described. Since the embodiment 2 includes common points with the embodiment 1, description will be omitted for the common points, and differences will be mainly described.

In the embodiment 1, the SUM value is generated in the GTP terminating unit 21 and is transmitted to the IP terminating unit 23. In the embodiment 2, an example that the SUM value is generated in the signal relay unit 22 will be described. Abase station 1B (an example of the communication apparatus) relating to the embodiment 2 may adopt the configuration illustrated in FIG. 3.

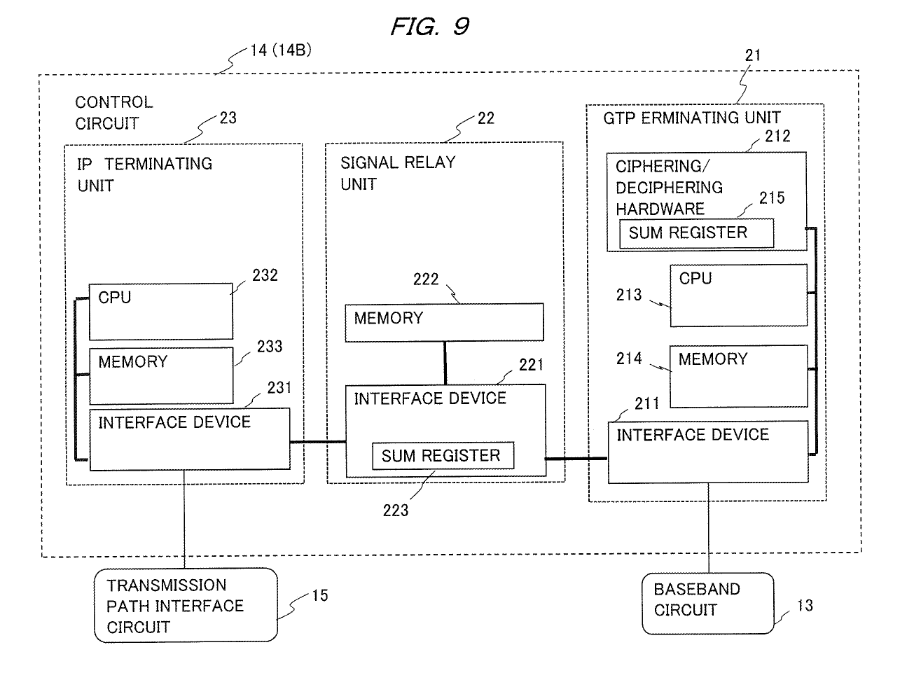

FIG. 9 illustrates a configuration example of the control circuit 14 (described as a control circuit 14B) of the base station 1B in the embodiment 2. In the embodiment 2, the ciphering/deciphering hardware 212 of the GTP terminating unit 21 is not provided with the SUM register 215, and the SUM value is not calculated either.

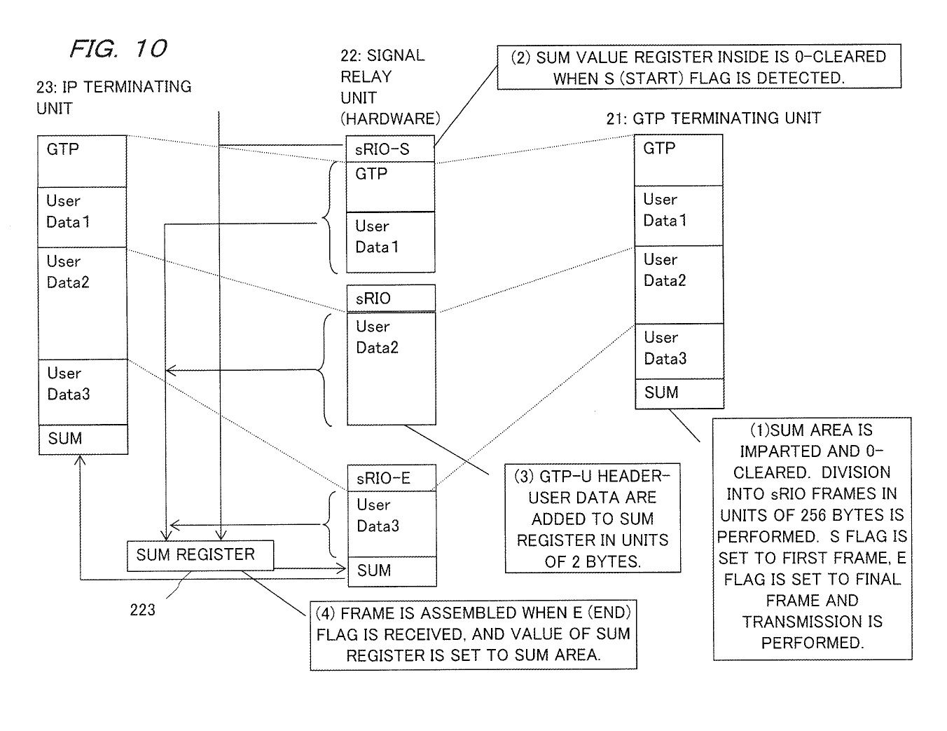

In contrast, the interface device 221 of the signal relay unit 22 is provided with a SUM register 223. FIG. 10 is an action explanatory drawing of the embodiment 2. In the embodiment 2, in the GTP terminating unit 21, the data block for which a storage area (2 bytes) of the SUM value is imparted to the GTP data (the GTP header and the user data) is generated. The SUM value is set to 0 (0x0000). The data block (the GTP data and the SUM value) is divided in units of 256 bytes, and the plurality of divided blocks are loaded onto the plurality of sRIO frames and transmitted. At the time, the GTP terminating unit 21 sets a start flag (S) to the header of a leading sRIO frame, and sets an end flag (E) to the header of a last sRIO frame (FIG. 10 (1)).

Last 2 bytes of the sRIO frame to which the end flag is set are set to the SUM value. At the time, in the case that the SUM value is over two sRIO frames, the padding (1 byte) is provided between the user data and the SUM value.

In the signal relay unit 22 (interface device 221), the respective sRIO frames are stored in the memory 222 for the assembly of the sRIO frames. At the time, in the case that the sRIO frame having the start flag is detected, the assembly of the data block is started, and the value of the SUM register 223 is 0-cleared (FIG. 10 (2)).

The signal relay unit 22 restores the data block by connecting the payloads of a series of the sRIO frames. In addition, the signal relay unit stores the addition result for which the payloads of the sRIO frames are added in units of 2 bytes in the SUM register 223 (FIG. 10 (3)). At the time, 1 is added further in the case of the carry-over. However, the area of the SUM value is excluded from an addition object.

When the processing to the payload of the sRIO frame to which the end flag is set is ended, the assembly of the data block is ended. At the time, a state is such that the SUM value for which the GTP data is an object is stored in the SUM register 223. The signal relay unit 22 rewrites the value of the storage area of the SUM value in the assembled data block with the SUM value of the SUM register 223 (FIG. 10 (4)). The processing described above is performed accompanying read of the sRIO frames accompanying the assembly of the data block. The assembled data block is sent to the IP terminating unit 23.

In the IP terminating unit 23, in the calculation of the value to be set to a UDP checksum field, the addition in units of 2 bytes for the GTP header and the GTP payload is not performed, and the SUM value sent from the signal relay unit 22 is used.

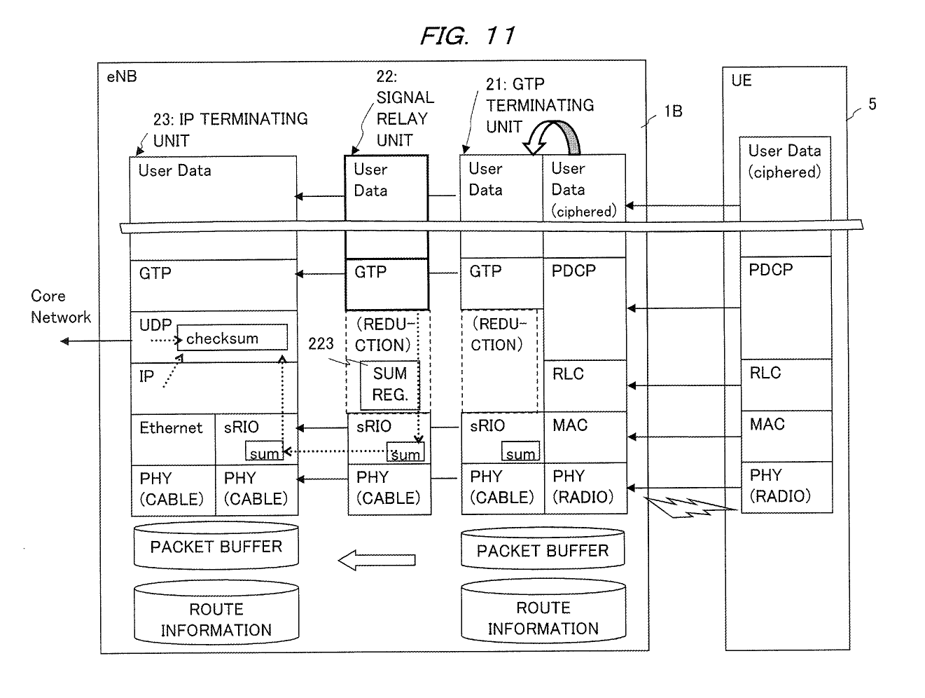

FIG. 11 is an explanatory drawing of a processing procedure of the GTP terminating unit 21, the signal relay unit 22 and the IP terminating unit 23 in the base station 1B relating to the embodiment 2. The terminal 5 transmits the PDCP packet including the ciphered user data to the base station 1B by radio. The GTP terminating unit 21 deciphers the user data. The GTP terminating unit 21 generates the GTP header by a method similar to that in the embodiment 1.

In the embodiment 2, the following processing different from that in the embodiment 1 is performed. The GTP terminating unit 21 provides the storage area of the SUM value in the free area at the end of the sRIO frame. The SUM value is set to 0. The GTP terminating unit 21 divides the GTP header, the user data and the SUM value, loads them onto the plurality of sRIO frames, and transmits them. At the time, the data is divided by a fixed length (256 bytes for example). The start flag is set to the leading sRIO frame, and the end flag is set to the last sRIO frame.

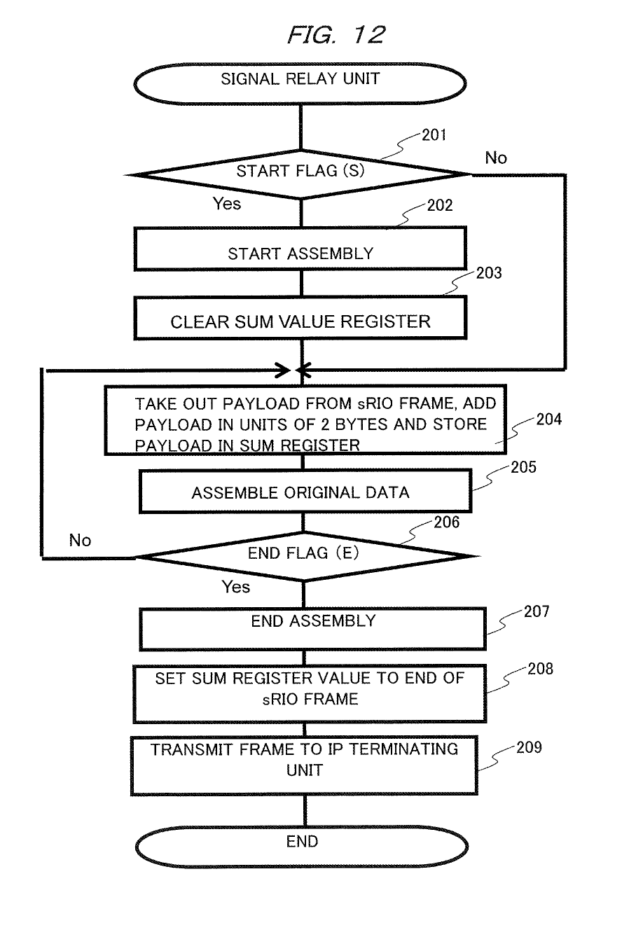

In the signal relay unit 22, the GTP header and the user data of the sRIO frame are added in units of 2 bytes, and the addition result is stored in the SUM register 223. FIG. 12 is a flowchart illustrating a processing example of the signal relay unit in the embodiment 2.

In the processing of 201, the signal relay unit 22 determines whether or not the received sRIO frame includes the start flag. The processing advances to 204 when it is determined that the start flag is included, and the processing advances to 202 otherwise.

In the processing of 202, the signal relay unit 22 starts the assembly of the data. In the processing of 203, the signal relay unit 22 clears the value of the SUM value register. In the processing of 204, the signal relay unit 22 takes out the payload from the sRIO frame, and stores the value for which the payload is added in units of 2 bytes in the SUM register 223.

In the processing of 205, the signal relay unit 22 connects the payload with payload data read in advance and assembles original data. In 206, the signal relay unit 22 determines whether or not the end flag is set to the header of the sRIO frame. When it is determined that the end flag is not set, reception of the next sRIO frame is waited for, and the processing of 204-206 is performed. When it is determined that the end flag is set, the assembly of the data is ended (207), and the value of the SUM register 223 is set to the value of the area of the SUM value included in the sRIO frame (208). In 209, the signal relay unit 22 transmits the frame (the GTP header, the GTP payload, and the SUM value) for which the assembly is ended to the IP terminating unit 23.

Note that, in the description using FIG. 10, an example that the SUM value in the sRIO frame is rewritten to the value of the SUM register 223 in the signal relay unit 22 and the respective sRIO frames are transmitted to the IP terminating unit 23 is described. Instead, as illustrated in FIG. 12, the original data may be assembled in the signal relay unit 22, the SUM value may be imparted, and transmission may be performed to the IP terminating unit 23.

The processing in the IP terminating unit 23 is similar to that in the embodiment 1 so that the description will be omitted. However, the GTP header and the GTP payload are not used in the calculation of the UDP checksum, and the SUM value obtained from the signal relay unit 22 is used. While the sRIO is an example of an internal communication system in the embodiments 1 and 2, it may be the LAN, the ATM or the PCI. The processing similar to that in the reference example may be performed in the case that the size of the user data is small (about 100 bytes or smaller) in the embodiment 2 as well.

In this way, in the base station 1B relating to the embodiment 2, the signal relay unit 22 (the interface device 221: an example of a first calculation unit of a first calculator) adds the payloads (the GTP header and the GTP payload (user data)) of the respective sRIO frames to the SUM register in units of 2 bytes. Thus, the total sum (SUM value) of the GTP header and the GTP payload is stored in the SUM register 223. The SUM value stored in the SUM register 223 is sent to the IP terminating unit 23 (an example of a generation unit of a generator and a second calculation unit or second calculator), and the IP terminating unit 23 uses the SUM value in the checksum calculation of the UDP header. Thus, generation of the time relating to the checksum calculation and waiting time of the memory access may be suppressed, and the increase in the transmission delay may be suppressed.

In the embodiment 2, the effects similar to that of the embodiment 1 are obtained. In addition, in the embodiment 2, since the SUM value is calculated in the signal relay unit 22 (an example of a relay unit or a relay device), the GTP header maybe also included in the object for the SUM value differently from the embodiment 1. Therefore, even in the case that hardware of the GTP terminating unit (PDCP terminating unit) is not changed, the increase in the transmission delay may be suppressed by using the SUM value. In the embodiment 2, the signal relay unit 22 is an example of “a circuit”, the memory 233 is an example of “a memory”, and the CPU 232 is an example of “a processor coupled to a memory”.

### Embodiment 3

Next, abase station and a checksum generation method relating to the embodiment 3 will be described. Since the embodiment 3 includes common points with the embodiment 1, the description will be omitted for the common points, and differences will be mainly described.

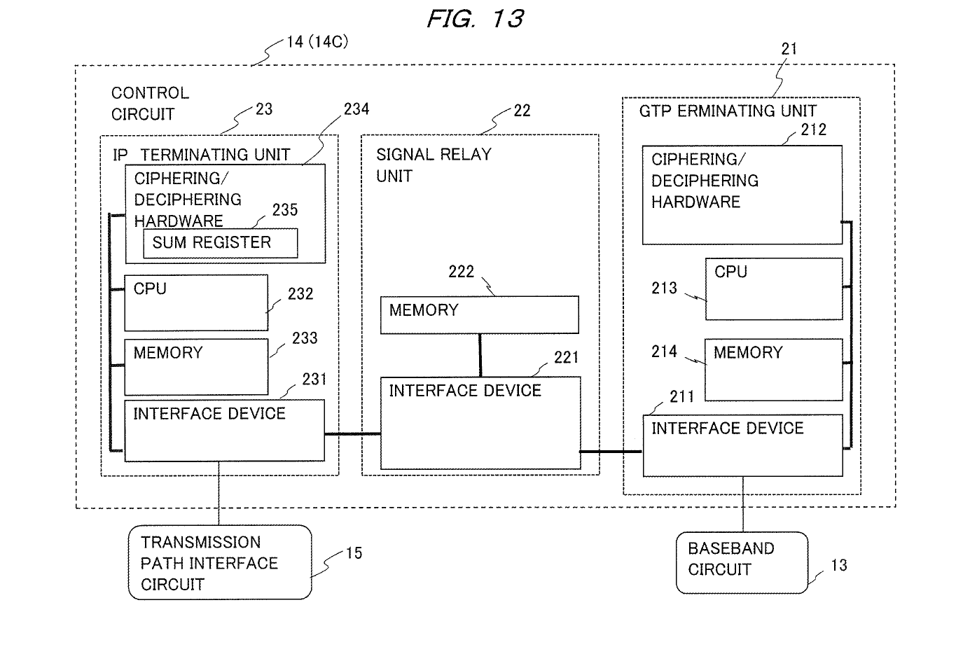

The base station 1 (described as a base station 1C: an example of the communication apparatus) relating to the embodiment 3 may adopt the configuration illustrated in FIG. 3. FIG. 13 illustrates a configuration example of the control circuit 14 (described as a control circuit 14C) of the base station 1C in the embodiment 3. In the control circuit 14C relating to the embodiment 3, the ciphering/deciphering hardware 212 (an example of the deciphering unit (decipher)) is not provided with the SUM register 215. In contrast, it is different from the embodiment 1 (FIG. 4) at a point that the IP terminating unit 23 includes ciphering/deciphering hardware 234 including a SUM register 235. The other points are similar to the embodiment 1 so that the description will be omitted.

Note that the GTP terminating unit 21 (CPU 213) is an example of the generation unit (generator) of the data block, the interface device 231 is an example “reception unit (receiver)” and “transmission unit (transmitter)”, and the memory 233 is an example of “storage unit (storage)”. The IP terminating unit 23 (CPU 232) is an example of “setting unit (setter)”.

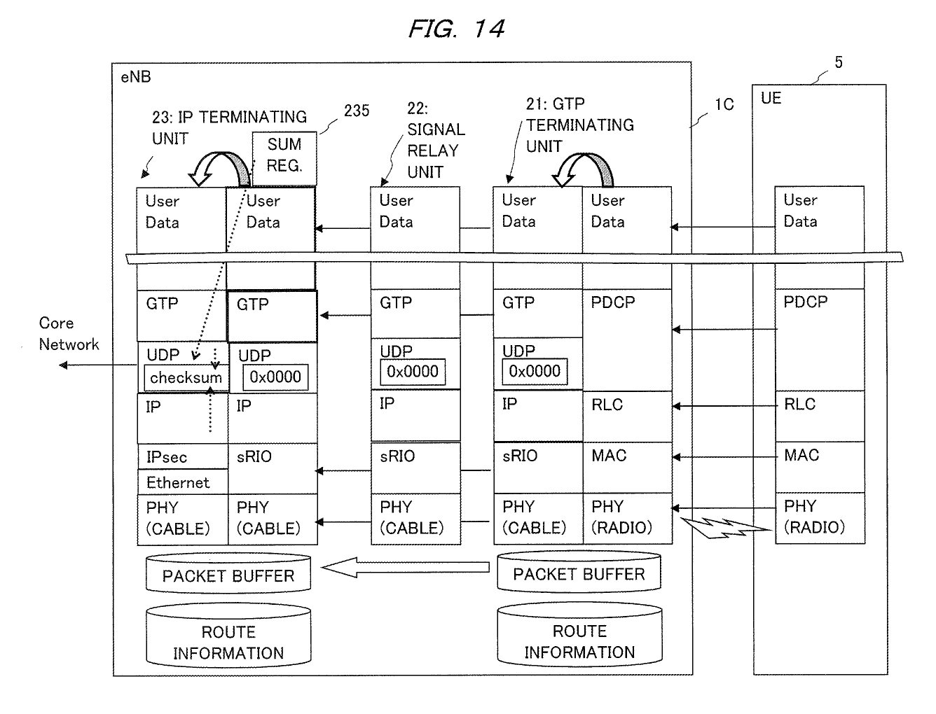

FIG. 14 is a diagram describing a processing procedure in the base station 1C relating to the embodiment 3. In the embodiment 3, the GTP terminating unit 21 generates not just the GTP header but also the UDP and the IP headers. However, the GTP terminating unit 21 (UDP terminating unit) specifies 0x0000 for the value of the UDP checksum. 0x0000 indicates checksum invalidation.

The data (the user data, the GTP header, the UDP header, and the IP header) generated in the GTP terminating unit 21 is transmitted to the IP terminating unit 23 through the signal relay unit 22, and is stored in the memory 233. In the IP terminating unit 23, the data stored in the memory 233 is accessed for IPsec ciphering, and the user data is read. At the time, the UDP checksum calculation is performed.

The GTP terminating unit 21 sets 0x0000 for the checksum value of the UDP header without performing the checksum calculation in the case that a packet size is large (100 bytes or more for example). In the case of being smaller than 100 bytes, the processing similar to that in the reference example is performed.

The ciphering/deciphering hardware 234 included in the IP terminating unit 23 executes the following processing in the case that the checksum is 0x0000. When reading the data (user data) of a ciphering object from the memory 233, the ciphering/deciphering hardware 234 stores the value for which the data (the GTP header and the GTP payload) of a UDP payload part is added in units of 2 bytes in the SUM register 235. In the case of the carry-over, 1 is added.

The ciphering/deciphering hardware 234 obtains the addition result in units of 2 bytes of the object part of the UDP checksum calculation of the IP header and the UDP header. The ciphering/deciphering hardware 234 sets the value obtained by adding and inverting (taking the complement of 1) the addition result and the value of the SUM register 235 to the UDP header as the UDP checksum value.

An IPsec terminating unit (the CPU 232, it may be exclusive hardware) included in the IP terminating unit 23 ciphers an IPsec packet. The IP terminating unit 23 transmits the ciphered packet to the core network 4. A reception device of the ciphered packet in the core network 4 cancels ciphering, calculates the UDP checksum, and performs the processing when it is correct.

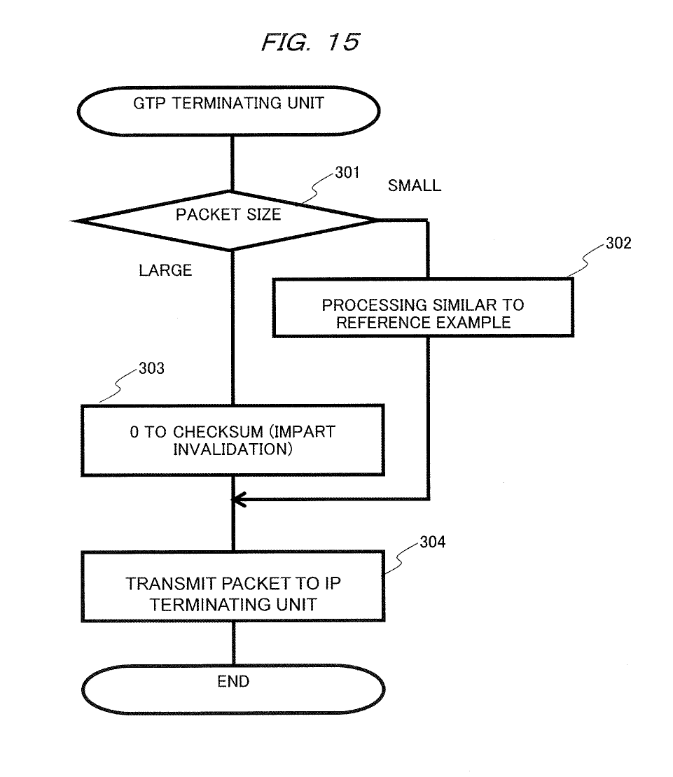

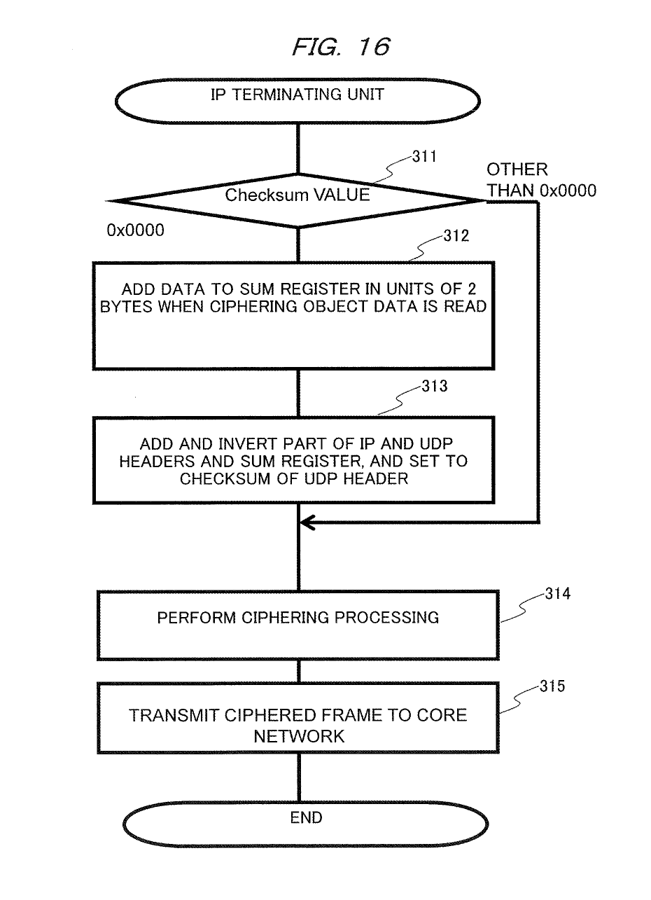

FIG. 15 is a flowchart illustrating a processing example of the GTP terminating unit in the embodiment 3. FIG. 16 is a flowchart illustrating a processing example of the IP terminating unit in the embodiment 3. In the processing of 301, the GTP terminating unit 21 generates the IP packet, and determines whether or not the packet size is larger than a predetermined size (large). The processing advances to 303 when it is determined that it is equal to or larger than the predetermined size, and the processing similar to that in the reference example is performed otherwise. That is, valid UDP checksum calculation and UDP header setting are performed (302). In the processing of 303, 0x0000 (indicating the invalidation) is set to the value of the UDP checksum of the UDP header. In 304, the GTP terminating unit 21 transmits the IP packet to the IP terminating unit 23.

In the processing of 311 in FIG. 16, the IP terminating unit 23 determines whether or not the checksum value is 0 (invalid). The processing advances to 312 when it is determined as being invalid, and the processing of 314 is performed otherwise. In the processing of 312, while the data of the ciphering object of IPsec is read from the memory 233, the addition is performed in units of 2 bytes, and the addition result is stored in the SUM register 235.

In the processing of 313, the total sum of the addition in units of 2 bytes of a part of the IP and UDP headers and the value of the SUM register 235 are added and inverted and the UDP checksum value to be set to the UDP header is calculated. In 314, the ciphering based on IPsec is performed, and the ciphered packet is transmitted to the core network. In the embodiment 3, the CPU 213 is an example of “a first processor”, the memory 214 is an example of “a first memory”, the CPU 232 is an example of “a second processor coupled to a second memory”, and the memory 233 is an example of “a second memory”.

### Effects of Embodiments 1-3

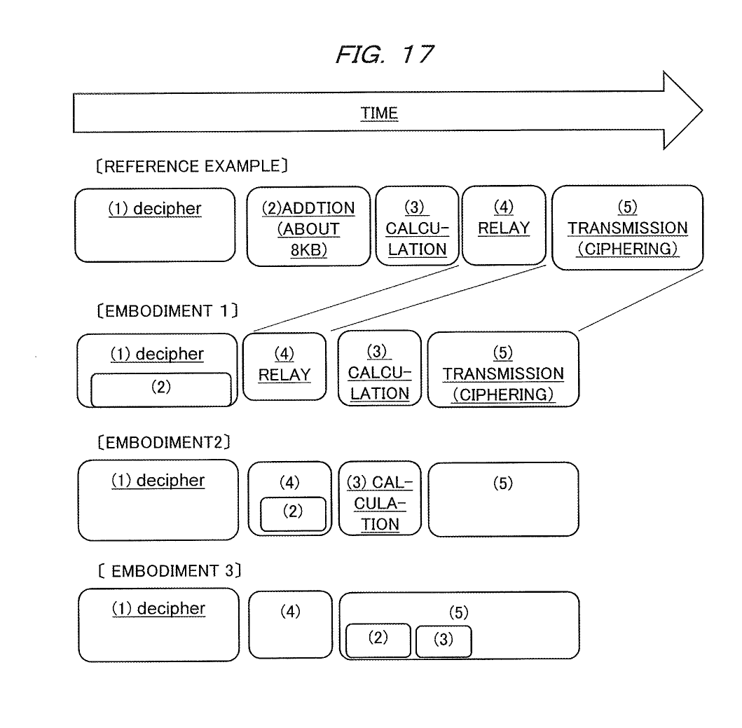

Also in the embodiment 3, similarly to the embodiments 1 and 2, the transmission delay due to the memory access for the UDP checksum calculation in a GTP processing unit may be suppressed (see FIG. 17). In addition, the bit transformation of the checksum value may be detected in the opposite apparatus of the base station. Note that the configurations described in the embodiments 1-3 may be appropriately combined. A TCP (Transmission Control Protocol) may be applied instead of the UDP (an example of the second protocol).

According to the embodiments, it is able to provide a communication apparatus and a communication method capable of suppressing increase in transmission delay.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

The above-mentioned embodiments disclose additions below.
(Addition 1) A communication method, comprising:

deciphering ciphered data; storing deciphered data for which the ciphered data is deciphered, a header of a first protocol including the deciphered data in a payload and an addition value for which the deciphered data is added in a predetermined size unit;

generating, using a first processor coupled to a first memory, a packet including the header of the first protocol, a payload that the deciphered data is stored, a header of a second protocol, and a header of a third protocol, a layer of the second protocol and the third protocol being lower than a layer of the first protocol;

calculating, using a second processor coupled to a second memory, a checksum value set to the header of the second protocol using the addition value; and

transmitting the packet to which the checksum value is set to the header of the second protocol.

(Addition 2) The communication method of the communication apparatus according to addition 1, further comprising storing the addition value for the deciphered data upon the deciphering.
(addition 3) The communication method of the communication apparatus according to addition 1, further comprising generating an addition value for which the deciphered data and the header of the first protocol are added in a predetermined size.

(Addition 4) A communication method, comprising:

deciphering received ciphered data;

calculating, using a first processor coupled to a first memory, an addition value for which deciphered data obtained by the deciphering and the header of the first protocol are added in a predetermined size unit when assembling an original data block using a plurality of divided blocks obtained by dividing a data block including the deciphered data, a header of a first protocol including the deciphered data in a payload and an area of an addition area;

setting, using the first processor, the addition value to an area of the addition value in the assembled data block;

generating, using a second processor coupled to a second memory and the assembled data block, a packet including the deciphered data, the header of the first protocol, and a header of a second protocol and a header of a third protocol, a layer of the second protocol and the third protocol being lower than a layer of the first protocol;

calculating, using the second processor, a checksum value to be set to the header of the second protocol using the addition value set to the area of the addition value; and

transmitting the packet for which the checksum value is set to the header of the second protocol.

(Addition 5) A communication method, comprising:

deciphering received ciphered data; generating, using a first processor coupled to a first memory, a data block that includes deciphered data obtained by the deciphering, a header of a first protocol including the deciphered data in a payload, and a header of a second protocol and a header of a third protocol, and for which a checksum value in the header of the second protocol is set as being invalid, a layer of the second protocol and the third protocol being lower than a layer of the first protocol;

receiving and storing the data block;

reading the stored data block;

ciphering, using a second processor coupled to a second memory, a packet including the deciphered data, the header of the first protocol, the header of the second protocol and the header of the third protocol;

calculating, using the second processor, the checksum value using the read data block and setting the checksum value to the header of the second protocol; and

transmitting the packet to which the checksum value is set and which is ciphered.

What is claimed is:

1. A communication apparatus, comprising:
a decipher configured to deciphers received ciphered data;
a first memory;
a first processor coupled to the first memory and configured to:
generate, when receiving deciphered data for which the ciphered data is deciphered, a header of a first protocol including the deciphered data in a payload and an addition value for which the deciphered data is added in a predetermined size unit, a packet including the deciphered data, the header of the first protocol, and a header of a second protocol and a header of a third protocol, a layer of the second protocol and the third protocol being lower than a layer of the first protocol;
a second memory;
a second processor coupled to the second memory and configured to calculate a checksum value set to the header of the second protocol using the addition value; and
a transmitter configured to transmit the packet to which the checksum value is set.

2. The communication apparatus according to claim 1, further comprising a memory to store the addition value for the deciphered data.

3. The communication apparatus according to claim 1, further comprising a relay device configured to generate the addition value for which the deciphered data and the header of the first protocol to be transmitted to the first processor are added in a predetermined size, and to transmit the addition value to the first processor.

4. A communication apparatus, comprising:
a decipher configured to decipher received ciphered data;
a circuit configured to:
calculate an addition value for which deciphered data obtained by the decipher and a header of a first protocol including the deciphered data in a payload are added in a predetermined size unit when receiving a plurality of divided blocks generated by dividing a data block including the deciphered data, the header of the first protocol and an area of an addition value and assembling an original data block; and
set the addition value to an area of the addition value in the assembled data block;
a memory;
a processor coupled to the memory and configured to:
generate a packet including the deciphered data, the header of the first protocol, and a header of a second protocol and a header of a third protocol when the data block is received, a layer of the second protocol and the third protocol being lower than a layer of the first protocol; and
calculate a checksum value to be set to the header of the second protocol using the addition value set to the area of the addition value; and
a transmitter configured to transmit the packet for which the checksum value is set to the header of the second protocol.

5. A communication apparatus, comprising:
a decipher configured to decipher received ciphered data;
a first memory;
a first processor coupled to the first memory and configured to:
generate a data block which includes deciphered data for which the ciphered data is deciphered, a header of a first protocol including the deciphered data in a payload, and a header of a second protocol and a header of a third protocol, and for which a checksum value in the header of the second protocol is set as being invalid, a layer of the second protocol and the third protocol being lower than a layer of the first protocol;
a second memory;
a receiver configured to receive the data block and stores the data block in the second memory;
a second processor coupled to the second memory and configured to:
calculate, when reading the data block from the storage unit and ciphering a packet including the deciphered data, the header of the first protocol, the header of the second protocol and the header of the third protocol, the checksum value using the read data block; and
set the checksum value to the header of the second protocol; and
a transmitter configured to transmit the packet to which the checksum value is set and which is ciphered.
